(19) United States
(12) Patent Application Publication
(10) Pub. No.: US 2004/0030631 A1
(43) Pub. Date: Feb. 12, 2004

(54) Systems and methods for facilitating real estate transactions

(75) Inventors: Eric Brown, Rancho Santa Fe, CA (US); Pertti Visuri, Fallbrook, CA (US); Robert Brown, La Mesa, CA (US)

Correspondence Address: PAUL, HASTINGS, JANOFSKY & WALKER LLP, P.O. BOX 919092, SAN DIEGO, CA, 92191-9092, US

(73) Assignee: Eric Brown

(21) Appl. No.: 10/342,111

(22) Filed: Jan. 13, 2003

Related U.S. Application Data
(60) Provisional application No. 60/347,738, filed on Jan. 11, 2002.

(51) Int. Cl. G06F 17/60

(52) U.S. Cl. 705/37

(57) ABSTRACT

A method and system used to assist buyers interested in renting, leasing, acquiring, or selling real property in the selection of appropriate real estate properties and facilitating the cooperation among various parties that contribute to the selection, transaction, and associated services. The method can use among other things a database of properties and associated information, Global Positioning Systems (GPS) technologies, Geographic Information Services (GIS) functions on a mobile device, a wireless communications network and handheld device, a suit of analytical tools, audio recording and playback capabilities; and personalized web portal functions.

### RELATED APPLICATION INFORMATION

This application claims priority under 35 U.S.C. 119 to U.S. Provisional Patent Application Ser. No. 60/347,738, entitled “METHOD AND SYSTEM FOR FACILITATING REAL ESTATE TRANSACTIONS”, filed on Jan. 11, 2002, which is included by reference in its entirety as if set forth herein.

### BACKGROUND

1. Field of the Inventions

The field of the invention relates generally to renting, leasing, acquiring, or selling real property and more particularly to the selection of appropriate real estate properties and the facilitation of cooperation among various parties that provide services related to such real property transaction.

2. Background Information

There are several operational inefficiencies that are inherent in the traditional method of conducting real estate transactions. Following is a description of the functions that are typically provided by brokers who represent buyers and sellers. The term “broker” is often used interchangeably herein with the term agent. It is recognized, however, that the broker and agent serve different functions and are often different individuals.

a. Functions of a Broker Representing a Buyer.

The purchaser's broker performs many functions including helping to coordinate financing, identifying and screening properties for viewing using the proprietary Multiple Listings Service (MLS), making arrangements for the prospective buyer to view the properties with the listing agent and the selling party, in addition to collecting information about comparable sales prices, community demographics and statistics. The majority of the work that the agent/property manager performs on behalf of the renter/lessee/buyer, which will be referred to collectively as the buyer, occurs before an “offer” is submitted to the opposite party, or seller. The agent must manage multiple relationships with prospective buyers—each with a specific set of preferences and needs. In addition, the agent balances the schedules of a plurality of buyers, along with related parties involved with each transaction, e.g. each buyers family members, financiers, inspectors, repairmen, etc., as well as the schedules of each corresponding seller and related parties, e.g. property manager, seller's agent, appraiser, escrow representatives, etc. Communicating all of the necessary information to all parties, and to personally guide the buyers to enable them to evaluate the properties, is a very time consuming task for the agent.

b. Functions of a Broker Representing a Seller:

The seller's broker provides advice on fixing up prior to showing, determines the list price, lists the property on the MLS and/or the Internet, assistance with marketing, e.g., signage, brochures, tours, open houses, etc., negotiates the offer, arranges the closing, and troubleshoots the gap between offer and closing. Like the broker representing the buyer, the seller's agent operates in a dynamic environment and must manage multiple relationships with quick response time.

The real estate environment is in a state of flux due to advancing technologies, regulatory changes, an increasing popularity of “discount” brokers, and in the popularity of for sale by owner transactions. These dynamics have exerted downward pressure on brokers' commission rates and fees. Moreover, all of the services that the broker can provide can be done faster and more efficiently by using the Internet, as opposed to relying only on communication between a broker and the client. The following paragraphs describe some exemplary inefficiencies that effect the traditional real estate transaction process.

First, current methods of communication and managing multiple relationships can impede the process for all parties. Constant interaction by related parties is required throughout the process. The real estate agent and the buyer must communicate before, during, and after each step prior to advancing to the next step. This dependency results in inefficiencies for both parties—the buyer must depend on the agent's ability to work efficiently and effectively, and the agent's capacity is constrained by the need to manage numerous activities for multiple parties.

Second, operational inefficiencies can impede the process for the broker, buyer, and seller. The operational inefficiencies are often felt most during the viewing process, which represents the most time consuming portion of the property search. Agents working with a prospective buyer scan the listings to find houses that suit the buyer's needs and interests. They then can make arrangements with listing agents to show the homes to the buyer. While viewing properties, the buyer must manage the information about each property viewed, which is a cumbersome process that can be difficult to manage—especially in the context of high-emotion real estate purchases.

A third problem is asymmetrical Information. Traditionally, buyers and sellers have had to consult brokers for information. This situation represents an inefficient market where each buyer or seller may not have equal access to information as other buyers or sellers. Such an arrangement has created a sentiment of distrust. For example, beginning in 1983 with a report by the Federal Trade Commission, the industry has been charged with failing to disclose whom the broker really represents, and the industry has appeared deceitful and untrustworthy to many.

Today's buyers and sellers are empowered because they can get information more easily. New technologies such as the Internet, which provides access to once proprietary real estate information, are transforming the way that buyers and sellers interact with their agent and other parties related to the real estate transaction. In the past, consumers had to consult brokers for information. This once specialized information is now becoming commoditized. For example, an increasing number of buyers are using the Internet to research and evaluate potential real estate properties for purchase, arranging financing, and assess recent sales information. This increased access empowers buyers to make more informed decisions, while also making the experience more productive for the real estate agent.

Although the Internet is improving the access of information by consumers, it has not bridged the gap to true efficiency. One reason for this is that there is no strong link from the informational Internet listings to the actual real estate transaction. Therefore, there is no good reward mechanism to provide a strong incentive for real estate brokers and agents to use the Internet in assisting buyers and sellers in real estate transactions.

### SUMMARY OF THE INVENTION

A method for facilitating a real estate transaction enables buyers and sellers to use the Internet to personalize their research parameters for a particular real estate target via a proprietary web portal, which can make available relevant information for downloading to a wirelessly-enabled Pocket PC or other type of portable device. Buyers can take the device to pre-screen the properties, i.e., “drive-by” viewing, at their convenience. The ability for buyers to pre-screen homes will result in a better qualified list of homes that the buyer would want to physically inspect. This will reduce the number of unnecessary showings that the buyer's real estate agent would have to arrange with the seller. In another aspect, navigational assistance is provided to the buyer directly to the buyer properties that he or she should find interesting based on information received from the buyer.

According to another aspect, providers of services or products can include a promotion of a discounted real estate service in their advertising messaging and receive a referral commission from the real estate brokers that use the system.

These and other features, aspects, and embodiments of the invention are described below in the section entitled “Detailed Description of the Preferred Embodiments.”

### BRIEF DESCRIPTION OF THE DRAWINGS

Features, aspects, and embodiments of the inventions are described in conjunction with the attached drawings, in which:

FIG. 1 is a diagram illustrating an example real estate transaction system configured in accordance with one embodiment of the invention;

FIG. 2 is a diagram illustrating the system of FIG. 1 including a portable device used by a buyer and the associated signaling that occurs within the system of FIG. 1 in accordance with one embodiment of the invention;

FIG. 3 is a diagram illustrating an example portable device configured in accordance with one embodiment of the invention; and

FIG. 4 is a diagram illustrating the various financial benefit flows in accordance with one embodiment of the invention.

### DETAILED DESCRIPTION OF THE PREFERRED EMBODIMENTS

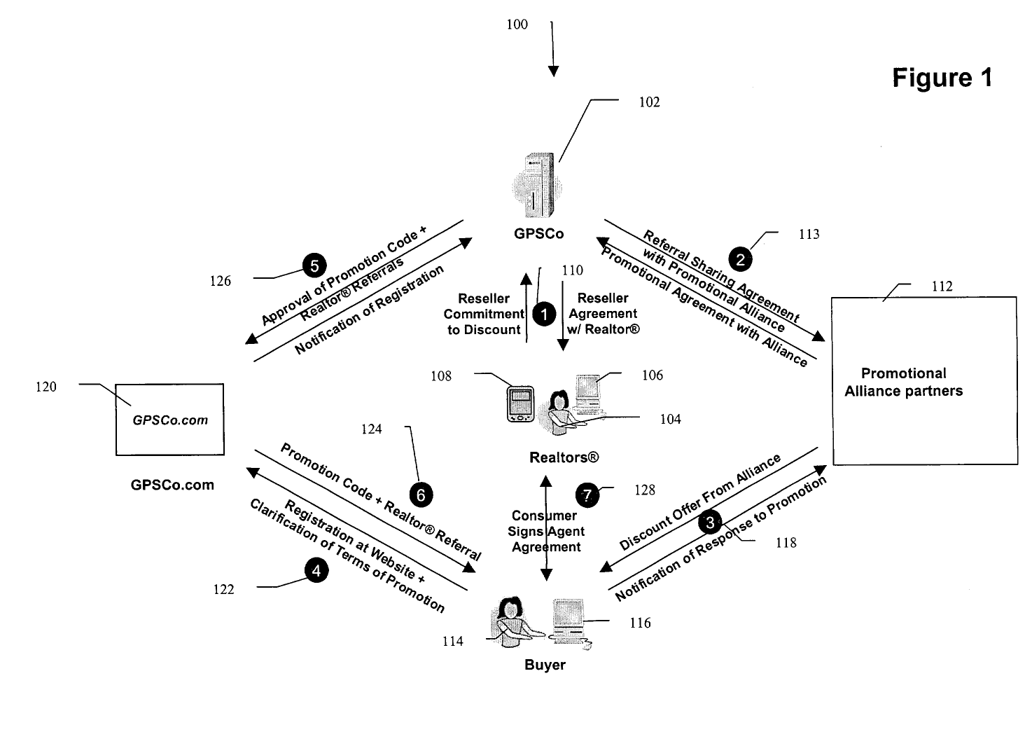

FIG. 1 is a diagram illustrating one embodiment of a real estate transaction system 100 configured in accordance with one example embodiment of the systems and methods described herein. The example embodiment of FIG. 1 depicts the signaling that can occur within system 100 from the broker's perspective. In FIG. 1, different components are represented by blocks and symbols and the transfers of information from one component to another are indicated by lines interconnecting the appropriate components. Each line can represent a transfer of certain information from one entity to another in the direction indicated by an arrow at the end of the line.

Though each block is labeled and will be described below as representing a particular component of system 100, it will be understood that each component of system 100 can be implemented by a computing device which performs the computations and the communications that are carried out by the particular component as described below. The computing devices might be any of a large variety of electronic devices including, for example, a personal computer, a PDA, a smart-card, a laptop computer, or a more powerful workstation, just to name a few. In addition, the communications media over which the transfers of information take place can also include any of a large number of possibilities, including telephone lines, cable, the Internet, satellite transmissions, or radio transmissions, for example. In other words, it is not intended that the systems and methods described herein be limited with regard to either the types of devices that are used or the methods of communication that are employed.

The central coordinating element in system 100 is real estate server (102), which can be configured to hold key information about relationships, agreements and links to related databases, services, and partner organizations. In one embodiment, the first interaction with real estate server (102) can be performed by a Realtor-reseller (104) who communicates a commitment of a selling commission discount and establishes a reseller agreement with real estate server (102) in step (110). Realtor-reseller (104) can have a communication system that consists of a personal computer, or a similar device, (106). Realtor-reseller (104) can also have a portable computing and communications device, such as portable device (108), that can communicate with the real estate server (102).

Another participant can be a promotional alliance partner (112), which can provide services that are of interest to potential customers of various realtors-resellers (104). These services can be information about real estate that is for sale or for rent, but they can also be other associated services, for example home repair supplies or services. They can also be services like wireless communication services. Promotional alliance partner (112) can communicate a promotional alliance agreement in step (113) whereby they will promote services associated with real estate server (102) and receive in return a referral fee, and possibly advertising placement opportunities on portable device (108).

An important participant is also buyer (114). Buyer (114) wants to acquire, i.e., purchase, rent, lease or otherwise identify and perform a transaction pertaining to a certain type of real property. Buyer (114) can be provided access to a communication system that consists of a personal computer, or a similar device, (116). Preferably, buyer (114) has access to the Internet, e.g., through personal device (116). In on example embodiment, buyer (114) notices a promotion of a promotional alliance partner (112), or otherwise learns about the services related to real estate server (102), e.g., via the Internet. When a buyer (114) does, in fact, notice a promotion, such as an offer to receive real estate related services at a discounted price, buyer (114) can respond, for example, by clicking on an appropriate actuator on a world wide web site configured for this purpose using methods that are well known in the industry, or by signaling the response by filling in a coupon at a retail outlet of a promotional partner in step (118).

Following the response to the promotion in step (118), buyer (114) can be connected or directed to, a personalized web page, or portal (120), on real estate server (102) using the internet or other suitable means of communication. In one embodiment, once buyer (114) is connected with real estate server (102), buyer (114) can be directed to register through portal (120) in step (122). Registration can, for example, comprise buyer (114) supplying relevant personal information, and information about the real property buyer (114) is interested in, through portal (120).

In some instances, promotional alliance partner (112) can be a real estate information site. In which case, some of the information may have been collected and can be supplied by promotional alliance partner (112). Next, in step (124) portal (120) can be configured to cause the registration information to be stored by real estate server (102), or an associated database, in step (126). Portal (120) can also be configured to receive from real estate server (102) an approval of the promotional code originating from promotional alliance partner (112) to whose promotion buyer (114) responded. This code can be passed to the real estate server (102) when buyer (114) is directed to portal (120).

Portal (120) can be configured to provide buyer (114) with a promotional discount code and referral information related to a realtor-reseller (104) that provides the desired real estate services at the agreed discount.

In step 128, buyer (114) and realtor-reseller (104) can then sign an agreement for services to be provided by realtor-reseller (104).

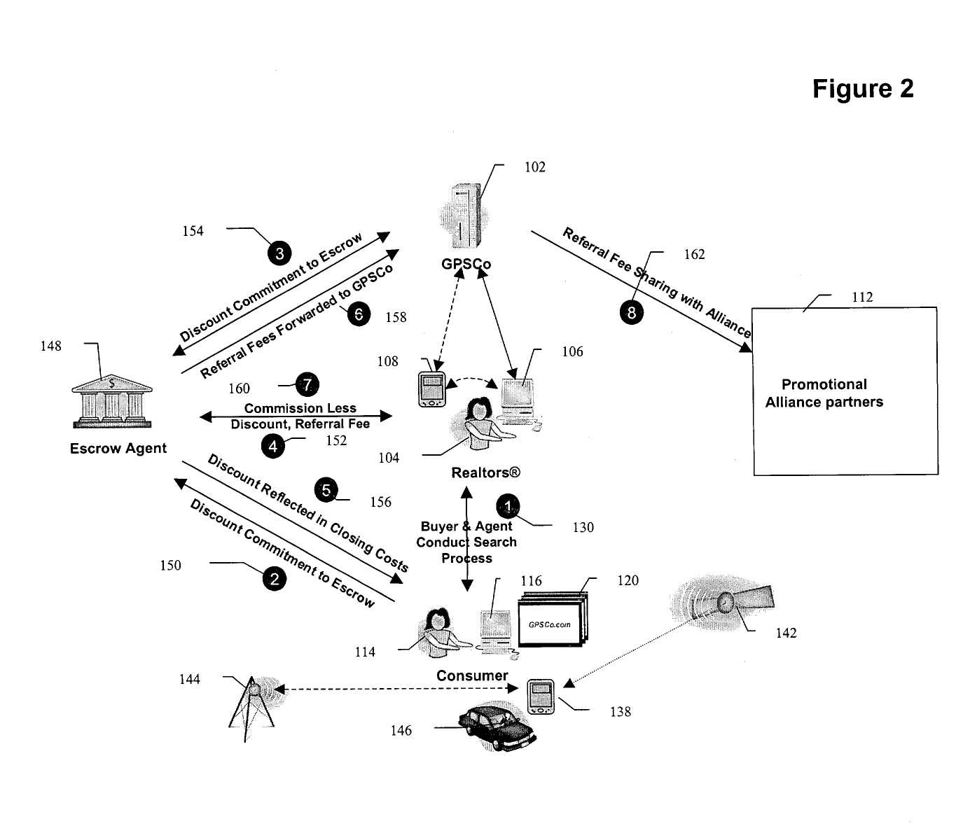

FIG. 2 is a diagram illustrating an exemplary real estate transaction process from the perspective of buyer (114). The process illustrated in FIG. 2 can begin, for example, after the process illustrated in FIG. 1 is complete. Thus, for example, after buyer (114) signs an agreement with realtor-reseller (104), in step (128), realtor-reseller (104) can conduct a search for properties that would meet with the criteria of buyer (114), in step (130). The search can be conducted using well known search methods for searching relational or other kinds of databases that contain information about properties that are offered for sale or lease or as subjects for any other kind of transactions that would be of interest to buyer (114). The search can, for example, use the functions and database connections available through real estate server (102). There is no need for buyer (114) to be physically at the location of the realtor-reseller (104) when the search is conducted. Rather, they can communicate using their associated communication systems and via telephone.

Once a collection of real properties that are of interest to buyer (114) has been established, realtor-reseller (104) download information about those properties to a portable device, such as portable device (138) or portable device (108). Thus, for example, the download can happen at the realtor-reseller's office to a realtor owned and controlled portable device (108), or if buyer (114) has a suitable portable device (138) available with a communication link to realtor-reseller (104), then information can be downloaded to the portable device (138). The information can be detailed information including information about the properties' location, interior and exterior photographs, video walk through presentations, etc., or it can just be identifying information, in which case detailed information about the properties can later be obtained.

At the same time realtor-reseller (104), and/or buyer (114), can cause the information about the properties that are of interest to buyer (114) to be stored by real estate server (102) for retrieval, for example, through portal (120) by buyer (114), realtor-reseller (104), or any other interested and authorized party. The retrieval can take place using the associated communication systems, including portable devices (108) or (138), or any other computer connected to real estate server (102). Further access information related to a specific buyer (114) can be protected, for example, by using a secret password or any other well known method for authentication.

The information can then be used by buyer (114) to evaluate the identified properties. Moreover, buyer (114) can take the information with them when they visit the properties to perform a screening. Based on the screening, buyer (114) can determine for which properties they would actually like realtor-reseller (104) to setup appointments. For example, using either portable device (138), or portable device (108), which the realtor-reseller (104) can make available as part of the associated service, buyer (114) can download the information in step (130), and use it to prescreen the identified properties. In this manner buyer (114) can conduct most of the property evaluation without time consuming help from the realtor-reseller (104).

In one embodiment, buyer (114) can even be provided navigational assistance, through portable device (108) or (138), to help them locate the identified properties. For example, in one implementation, portable device (108) or (138) can comprise GPS location capabilities that allow portable device (108) or (138) to receive position information from GPS satellites, e.g., satellite (142), and convert this information into driving directions that can be displayed to buyer (114). In another embodiment, portable device (108) or (138) can also have wireless access information about, e.g., a particular neighborhood, about real properties of interest, or promotional messages from promotional alliance partners (112) or others, via wireless data network (144).

Once buyer (114) has selected a property, buyer (114) can communicate the selection to the realtor-reseller (104) and to an escrow services provider (148). Buyer (114) can include information about the agreed discount in step (150). Escrow agent (148) verifies the discount and referral fee agreements with realtor-reseller (104) and real estate server (102) in steps (152) and (154). The discount is then reflected in the closing costs provided to the buyer (114) in step (156). The agreed referral fee is then forwarded to Real estate server (102) in step (158) and Realtor-reseller (104) gets the balance, i.e., the commission less discount and referral fee, in step (160).

Based on the promotional code that was registered with real estate server (102) in step (124), and based on the agreement with promotional alliance partner (112) real estate server (102) can issue a payment to promotional alliance partner (112) in step (162).

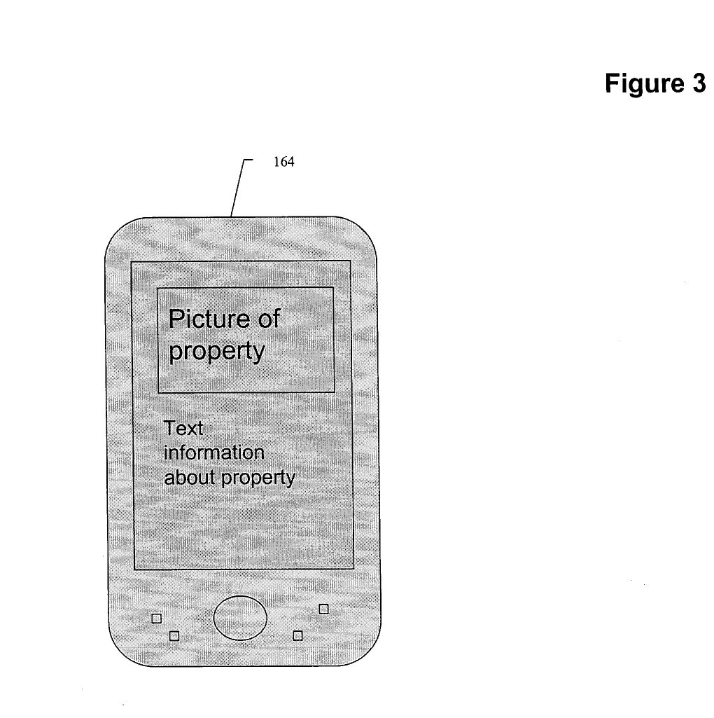

FIG. 3 illustrates an exemplary portable device (164) configured in accordance with one embodiment of the systems and methods described herein. Portable device (164) can be configured to display various information including alphanumeric information, maps of diagrams, photographs, video and virtual three dimensional walk through information about the properties of interest to a buyer. Portable device (164) can, for example, include an internal menu system that lets the buyer view lists and select specific properties for more detailed examination.

Portable device (164) can also be configured to display navigational information related to the properties of interest. For example, in one embodiment, portable device (164) can include positioning capability. In such embodiments, the navigational information can be based on position information acquired by device (164). In one specific implementation, portable device (164) can include a Global Positioning System (GPS) based navigation system that uses well known industry solutions to provide turn by turn type guidance to the various properties. The prompts for the guidance can be both visual and audible. A route planning algorithm can provide route optimization for multiple destinations. The navigation calculations can be performed either using the portable device's resources or using server based navigation algorithms. In one embodiment, the address information about any property can be automatically passed on to the navigation system. Preferably, all the buyer needs to do is to click on a button on the display, labeled “take me there” or something similar, and the navigational system can calculate the route and begin providing navigational information.

In another embodiment, the GPS positional information can be used to more conveniently retrieve information from portable device (164). For example, information can be accessed based on how close property is located to the present position of the portable device (164). Thus, using GPS, or other navigational capability, a buyer can be directed to properties near their present location for convenient viewing. Once at a property, the buyer can then preferably access information related to the property, such as photographs, video clips, etc.

In another embodiment, the buyer can also call up information about comparable properties within a certain distance of the device's current location. Lists of comparable properties can also be generated based on features or location information of any of the properties whose information has been accessed through portable device (164). Comparables can, for example, include properties for sale, or properties that have been for sale or properties that have been sold, or any combination thereof.

Portable device (164) can comprise data communication capability that uses a wireless data network connection, like the ones commercially available from companies like Verizon, Cingular, Sprint, or ATT, and it can enable the buyer to access more detailed information about properties, or the community and surroundings. Thus, property information can be retrieved, for example, from the portal (120) or from other Internet based sources via a wireless data network connection. Such information can, therefore, be made available in suitable form, for example, from a Multiple Listing Service (MLS) databases, or companies that provide access to them.

Portable device (164) can be configured to receive feedback related to properties screened by the buyer. For example, in one embodiment, portable device (164) can be configured to record notes and can be equipped to take photographs or video clips of the properties that area being evaluated. Portable device (164) can also be configured to use a pre-loaded detailed check list to enter ratings or rankings for various aspects of the property based on comparisons between alternative properties. Portable device (164) can be configured to also use its positioning capability to collect information related to where the buyer has been with portable device (136) and/or the how much time the buyer spent at various properties.

Portable device (164) can also be configured to synchronize the data on portable device (164), including recorded voice notes, with a personalized portal database associated with the buyer. The word “synchronize” in this context means that through a communication connection the same information can be stored both on portable device (164) and on real estate server (102). This communication connection can be through a physical means, for example using a so called cradle, or preferably through a convenient and continually available wireless data network connection. Both the buyer and the realtor-seller can be provided passwords or otherwise protected access to selected data.

Using the synchronize-function, a buyer can then, for example, store information about specific properties on real estate server (102) to make them available for later review. For example, a buyer can create a favorites list of properties and store all the initially available information about properties in the list. This information can, in certain embodiments be augmented later by storing any photographs, or video clips, and voice notes, or results of the comparative ratings or rankings the buyer created while visiting the properties.

Portable device (164) and the personalized portal can also include a facility for instant messaging and/or sending and receiving emails. Simple, one button access is preferably provided for sending messages to realtor-reseller (104) or to other parties involved with the search or transaction.

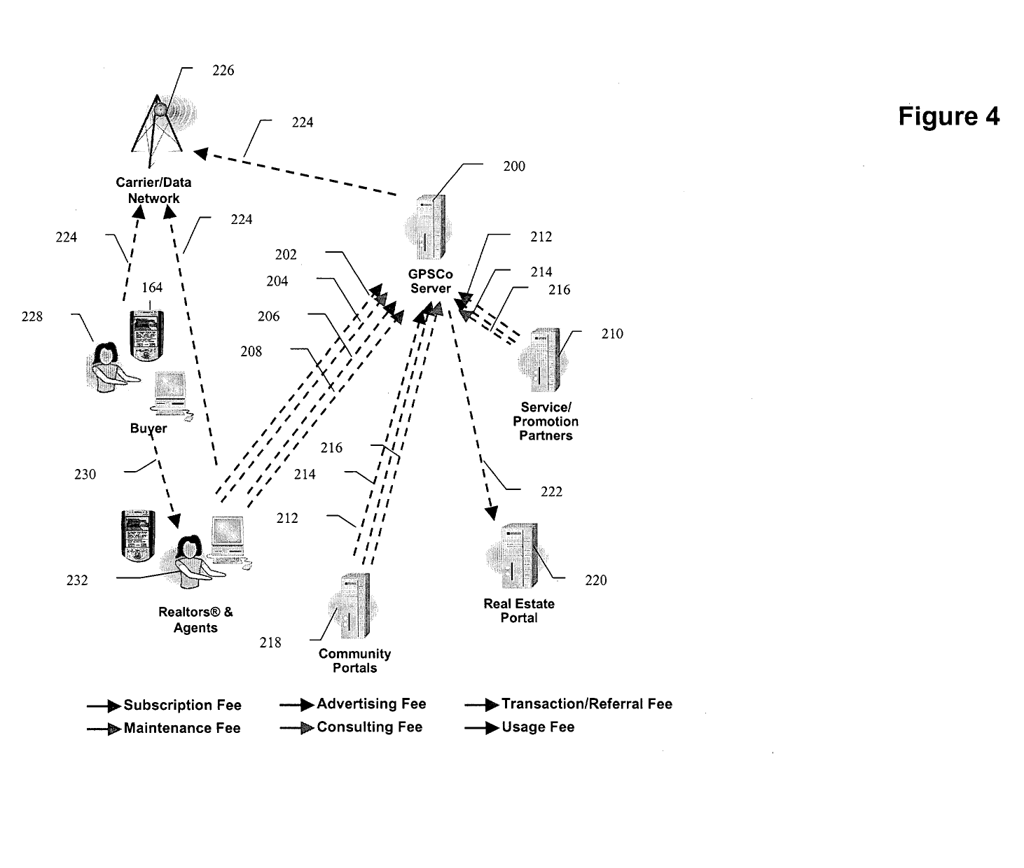

FIG. 4 is a diagram illustrating flows of revenues that result when the processes described above are implemented. Thus, the broker associated with real estate server (200) agrees to support the service described above for a particular realtor-reseller (1104), the broker receives a subscription fee in step (202). Depending on the embodiment, the broker can also receive a consulting fee for setting up the system in step (204), a maintenance fee for maintaining the system in step (206), and a transaction fee for consummating each transaction in step (208), which is described in conjunction with FIG. 2.

Advertising on portable device (164) and on the personalized portal associated with the buyer can also generate revenue. A service promotion partner (210) can, for example, purchase the right to display advertisements on portable device (164) or the personalized portal. Because real estate server (200) can have access to information that involves real estate server (200) at what stage a particular buyer (228) is in the process, just in time advertising can be provided to a buyer (228). For example, a mortgage lender can elect to purchase the right to place an advertisement on the buyer's device (164) just at the time buyer (228) has narrowed down the selection to two or three properties, or when he or she is filling out a form on portable device (169) that facilitates sending an offer of a particular property. In another embodiment, a home repair or paint store can place an advertisement if buyer (228) has indicated a low score, or ranking for the exterior of a property that otherwise receives high marks.

In general, such advertising can result in advertising revenue streams for the broker in step (212). If buyer (228) responds to an advertisement, which may include a promotional code to track the response, the party who placed the advertisement can, depending on the embodiment, be obliged to pay a response fee in step (214). If the response leads to a purchase, then there can be a transaction fee in step (216). It should be noted that in certain embodiments, advertiser's can be aggregated through a community portal (218).

The broker will need to pay at least two parties in the example embodiment of FIG. 4. Information about properties available for sale rent or other transaction can be obtained through a real estate portal (220) that provides access to so called MLSs. To access such information, there is often a fee associated with using the service that is paid in step (222). To the extent the broker will use wireless data network services, a fee will likely need to be paid to the carrier or data network provider (226) in step (224). Other parties using the service will also pay such fees. It should be noted that both real estate portal (220) and the data network provider (226) can also be promotional partners thus offsetting the fees.

Finally buyer (228) who consummates a real estate transaction can be required to provide a transaction fee, or a commission, albeit discounted, to realtor-reseller (232). This fee can be a source of funding for realtor-reseller (232) to pay the various fees to the broker.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A portable device, comprising a display, a user interface, and a communication interface, the portable device configured to:
download information through the communication interface related to a plurality of properties, each of the plurality of properties having been selected based on user supplied criteria,
cause the downloaded information to be displayed on the display; and
receive feedback through the user interface related to each of the plurality of properties for which information was downloaded.

2. The portable device of claim 1, further configured to display navigational information on the display related to one or more of the plurality of properties.

3. The portable device of claim 2, further comprising positioning capabilities, wherein the navigational information is based on position information acquired with the positional capabilities of the portable device.

4. The portable device of claim 1, further configured to forward the feedback to a realtor-reseller via the communication interface.

5. The portable device of claim 1, further configured to cause information related to the plurality of properties to be stored on a personalized portal for later review and retrieval.

6. The portable device of claim 1, wherein the information stored on the portal includes the feedback related to each of the plurality of properties.

7. The portable device of claim 6, wherein the feedback includes ranking or scoring of each of the plurality of portable devices.

8. The portable device of claim 1, further configured to download promotional information through the communication interface and to display the promotional information on the display.

9. The portable device of claim 8, further configured to receive a response the promotional information through the user interface.

10. The portable device of claim 9, further configured to forward the response to a real estate server.

11. The portable device of claim 1, further configured to receive a request for information through the user interface, download the requested information through the communication interface, and display the requested information on the display.

12. The portable device of claim 11, wherein the received information request includes criteria and a request for information related to properties selected based on the criteria, and wherein the downloaded information includes information related to a plurality of properties, each of the plurality of properties having been selected based on the criteria provided.

13. The portable device of claim 1, wherein the downloaded information includes an address and a description of each of the plurality of properties.

14. The portable device of claim 13, wherein the downloaded information includes pictures or video clips of each of the plurality of properties.

15. The portable device of claim 1, wherein the received feedback includes an indication of the desirability of the particular property.

16. The portable device of claim 15, wherein the indication includes a ranking or scoring for the particular property.

17. A portable device, comprising a display, a user interface, and a communication interface, the portable device configured to:
download information through the communication interface related to a plurality of properties, each of the plurality of properties having been selected based on user supplied criteria,
cause the downloaded information to be displayed on the display; and
display navigational information on the display related to one or more of the plurality of properties.

18. The portable device of claim 17, further comprising positioning capabilities, wherein the navigational information is based on position information acquired with the positional capabilities of the portable device.

19. A method for facilitating a real estate transaction, comprising:
entering into a referral agreement with each of a plurality of promotional alliance partners;
entering into a discount agreement with a realtor-reseller, the discount agreement providing for a discount to be provide to the buyer in exchange for the buyer prescreening perspective properties with the aid of a portable device;
receiving a response from a buyer to a promotion associated with one of the plurality of promotional alliance partners;
registering the buyer;
facilitating the sale of a property to the buyer; and
collecting and distributing fees according to the referral agreement and the discount agreement.

20. The method of claim 19, wherein registering the buyer comprises:
receiving a promotional code associated with the promotion to which the buyer responded;
approving the promotional code; and
storing information related to the registration, the information including the promotional code.

21. The method of claim 19, wherein distributing the fees comprises:
distributing a referral fee to the promotional alliance partner associated wit the promotion responded to by the buyer; and
distributing a commission to the realtor-reseller that is discounted by an amount equal to the agreed to discount plus the referral fee.

22. A real estate server, comprising:
a memory configured to store instructions; and
a processor coupled with the memory, the processor configured to execute the instruction, the instructions configured to cause the real estate server to:
facilitate a referral agreement with each of a plurality of promotional alliance partners;
enter into a discount agreement with a realtor-reseller, the discount agreement providing for a discount to be provide to the buyer in exchange for the buyer prescreening perspective properties with the aid of a portable device;
receive a response from a buyer to a promotion associated with one of the plurality of promotional alliance partners;
register the buyer;
facilitate the sale of a property to the buyer; and
collect and distributing fees according to the referral agreement and the discount agreement.

23. The real estate server of claim 22, wherein the instructions are further configured to cause the real estate server to:
receive a promotional code associated with the promotion to which the buyer responded;
approve the promotional code; and
store information related to the registration, the information including the promotional code.

24. The real estate server of claim 22, wherein the instructions are further configured to cause the real estate server to:
distribute a referral fee to the promotional alliance partner associated with the promotion responded to by the buyer; and
distribute a commission to the realtor-reseller that is discounted by an amount equal to the agreed to discount plus the referral fee.
